(19) United States
(12) Patent Application Publication
(10) Pub. No.: US 2010/0074714 A1
(43) Pub. Date: Mar. 25, 2010

(54) Bookbinding device

(75) Inventors: Teruhito Oka, Arida-gun (JP); Hiroshi Miyawaki, Wakayamaj-shi (JP); Hiroo Michii, Kyoto-shi (JP)

Correspondence Address: JORDAN AND HAMBURG LLP, 122 EAST 42ND STREET, SUITE 4000, NEW YORK, NY, 10168, US

(73) Assignee: NORITSU KOKI CO., LTD., Wakayama-shi (JP)

(21) Appl. No.: 12/586,125

(22) Filed: Sep. 17, 2009

(30) Foreign Application Priority Data
Sep. 19, 2008 (JP) 2008-241481

(51) Int. Cl. B42C 13/00

(52) U.S. Cl. 412/14; 412/22

(57) ABSTRACT

Provided is a bookbinding device having a thickness measuring unit including a movable piece that moves according to the thickness of a sheet bundle to be bound, a bookbinding processing unit for performing bookbinding processing in a state of being positioned at a prescribed processing position, and a synchronization mechanism for changing the processing position of the bookbinding processing unit in synchronization with the movement of the movable piece.

### BACKGROUND OF THE INVENTION

1. Field of the Invention

The present invention relates to a bookbinding device that is devised so as to enable the easy performance of bookbinding processing.

2. Description of the Background Art

Conventionally, a bookbinding device as described in Japanese Patent Application Laid-Open No. 2003-231375 is known. This bookbinding device includes a clamp plate for fixing and holding a booklet, a pressing plate for pressing a back face of the booklet (sheet bundle) that is fixed and held by the clamp plate, and a nip plate positioned above the pressing plate and for pressure-holding both back face side ends of the booklet from booth ends thereof. During the bookbinding process, a cover that is positioned above the pressing plate and the nip plate is attached to the back face of the booklet with a hot-adhesive melt based on the pressure of the pressing plate and the pressure-hold of the nip plate.

As the hot-melt adhesive, a broad adhesive sheet that is cut in an elongated shape according to the thickness of the booklet detected by the booklet thickness detecting unit is used. This cut hot-melt adhesive is moved to the back face side position of the booklet. Subsequently, the cover is supplied to the booklet via the hot-melt adhesive, and the back face portion of the booklet is pressure-held by the nip plate. In this state, the hot-melt adhesive is heated with a heater provided to the pressing plate, and the bookbinding processing is completed when the back cover is bonded to the booklet end face.

The foregoing bookbinding device is generally automated; specifically, based on a detection signal detected by the booklet thickness detecting unit, the adhesive sheet is automatically fed and cut so as to become the thickness dimension, and the cover to be processed is automatically supplied. Consequently, the device cost is high, and, for instance, there is a problem in that it is too expensive for an individual to perform bookbinding processing in a simple and convenient manner.

### SUMMARY OF THE INVENTION

Thus, an object of the present invention is to provide a bookbinding device that is capable of easily and accurately performing bookbinding processing to a sheet bundle in a simple and convenient manner.

In order to achieve the foregoing object, the bookbinding device according to one aspect of the present invention includes a thickness measuring unit including a movable piece that moves according to the thickness of a sheet bundle to be book-bound, a bookbinding processing unit for performing bookbinding processing in a state of being positioned at a prescribed processing position, and a synchronization mechanism for changing the processing position of the bookbinding processing unit in synchronization with the movement of the movable piece.

According to the foregoing configuration, the movable piece moves in accordance with the thickness of the sheet bundle, and the processing position of the prescribed processing of the bookbinding processing unit is changed in synchronization with the movement of the movable piece. Accordingly, the operator is able to performing appropriate bookbinding according to the thickness of the sheet bundle merely by measuring the sheet bundle thickness and subsequently executing the bookbinding processing.

### BRIEF DESCRIPTION OF THE DRAWINGS

FIG. 1A and FIG. 1B are diagrams showing a booklet to be bound with the bookbinding device, wherein FIG. 1A is an exploded perspective view of the booklet, and FIG. 1B is an end face view showing the status immediately before the booklet is bound with the bookbinding device;

FIG. 2 is an exploded perspective view showing an embodiment of the bookbinding device according to the present invention;

FIG. 3 is a perspective view after the assembly of the bookbinding device illustrated in FIG. 2;

FIG. 4 is a perspective view after the assembly of the bookbinding device illustrated in FIG. 2, and shows a state of positioning the first and second processing blocks at the home position;

FIG. 5 is a V-V cross section of FIG. 4;

FIG. 6A and FIG. 6B are perspective views showing an embodiment of the bookbinding processing execution unit, wherein FIG. 6A is a partial cutaway exploded perspective view thereof, and FIG. 6B is a partial cutaway assembly perspective view thereof;

FIG. 7A to FIG. 10B are explanatory diagrams explaining the operation of the bookbinding device, wherein FIG. 7A is an explanatory diagram showing a planar view of the initial state of the bookbinding device prior to performing the bookbinding processing, and FIG. 7B is an explanatory diagram showing a lateral cross sectional view thereof;

FIG. 8A is an explanatory diagram showing a planar view where the thickness of the sheet bundle to be bound has been measured with the sheet bundle thickness measuring unit, and FIG. 8B is an explanatory diagram showing a lateral cross sectional view thereof;

FIG. 9A is an explanatory diagram showing a planar view of the bookbinding processing execution unit being moved from the home position toward the right side, and FIG. 9B is an explanatory diagram showing a lateral cross sectional view thereof; and

FIG. 10A is an explanatory diagram showing a planar view where the bookbinding processing execution unit has been moved to the rightmost end, and FIG. 10B is an explanatory diagram showing a lateral cross sectional view thereof.

### DESCRIPTION OF THE PREFERRED EMBODIMENTS

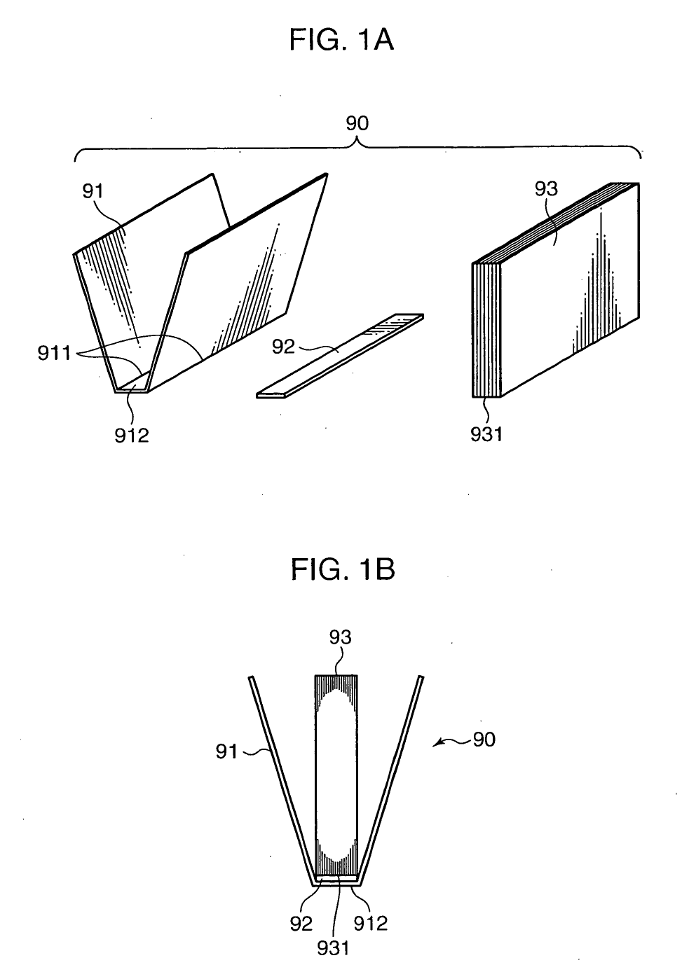

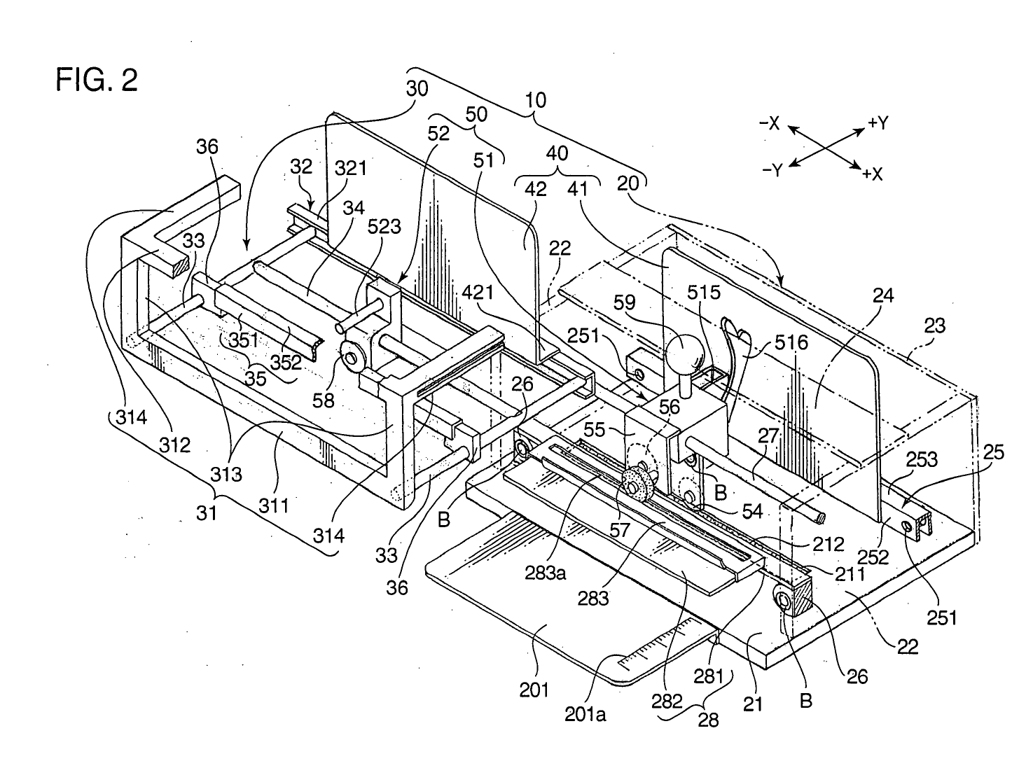

Prior to explaining the bookbinding device 10 (FIG. 2 to FIG. 4) according to an embodiment of the present invention, the bookbinding processing to be performed by the bookbinding device 10 is foremost explained. FIG. 1A and FIG. 1B are diagrams showing a booklet 90 to be bound with the bookbinding device 10, wherein FIG. 1A is an exploded perspective view of the booklet 90, and FIG. 1B is an end face view showing the status immediately before the booklet 90 is bound with the bookbinding device 10.

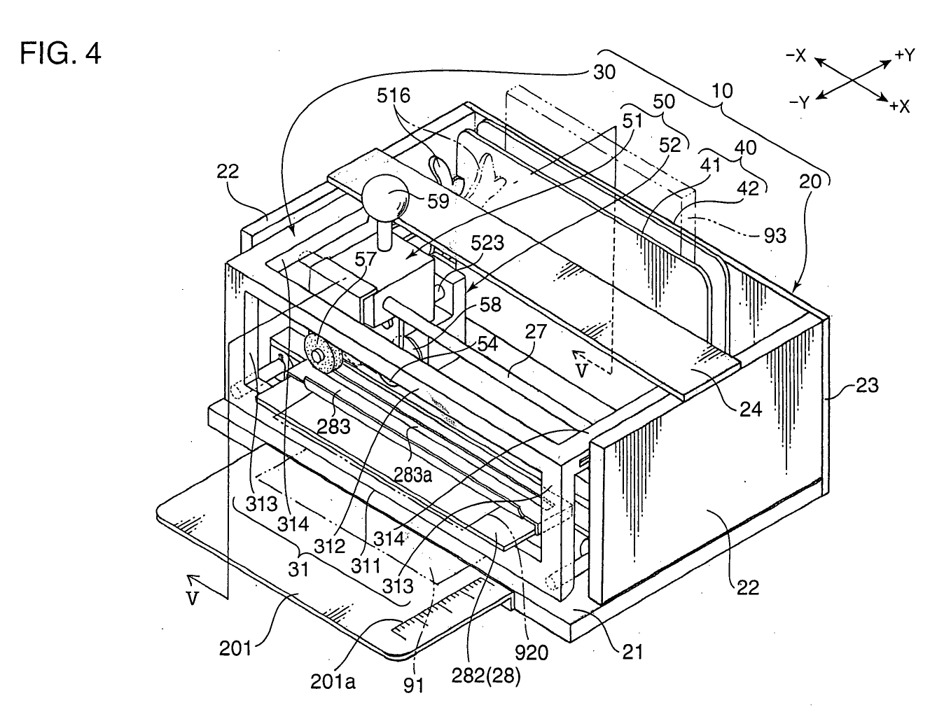

The booklet 90 is configured from a cover sheet 91 formed from a thick paper material, a hot-melt adhesive 92 that does not contain any water or solvent and of a solid sheet-shape at room temperature which melts by being heated, and a sheet bundle 93 formed, for instance, by laminating a plurality of sheets of recording paper or photo prints. Two creases 911 are provided near the center in the lateral direction of the cover sheet 91, and the section between the two creases 911 forms a back cover 912. The hot-melt adhesive 92 is formed by being cut according to the width size of the back cover 912 from a large tabular mother adhesive 920 (FIG. 4).

When performing the bookbinding processing with the bookbinding device 10, the user assembles, as shown in FIG. 1B, the cover sheet 91, the hot-melt adhesive 92 and the sheet bundle 93. Specifically, the hot-melt adhesive 92 is mounted on the counter part of the cover sheet 91 folded at the two creases 911; that is, mounted on the reverse side of the back cover 912. Moreover, the sheet bundle 93 is housed within the cover sheet 91 so that one side 931 of the sheet bundle 93 is placed on the hot-melt adhesive 92 so as to complete the booklet 90.

The user manually holds the booklet 90, and inserts it into an insertion space of the heating unit (not shown) from the back cover 912 side. The user subsequently presses the start switch to cause the heating unit to execute the heating processing. The hot-melt adhesive 92 is thereby heated and melted, and the cover sheet 91 and the sheet bundle 93 are bonded at the reverse side of the back cover 912, and the bookbinding processing of the booklet 90 is thereby complete.

The bookbinding device 10 according to the present embodiment is a device for performing, in the sequential bookbinding processing described above, the processing of creating the two creases 911 on the cover, and the cutting processing of cutting out the hot-melt adhesive 92 having a width dimension according to the thickness dimension of the sheet bundle 93 from the mother adhesive 920.

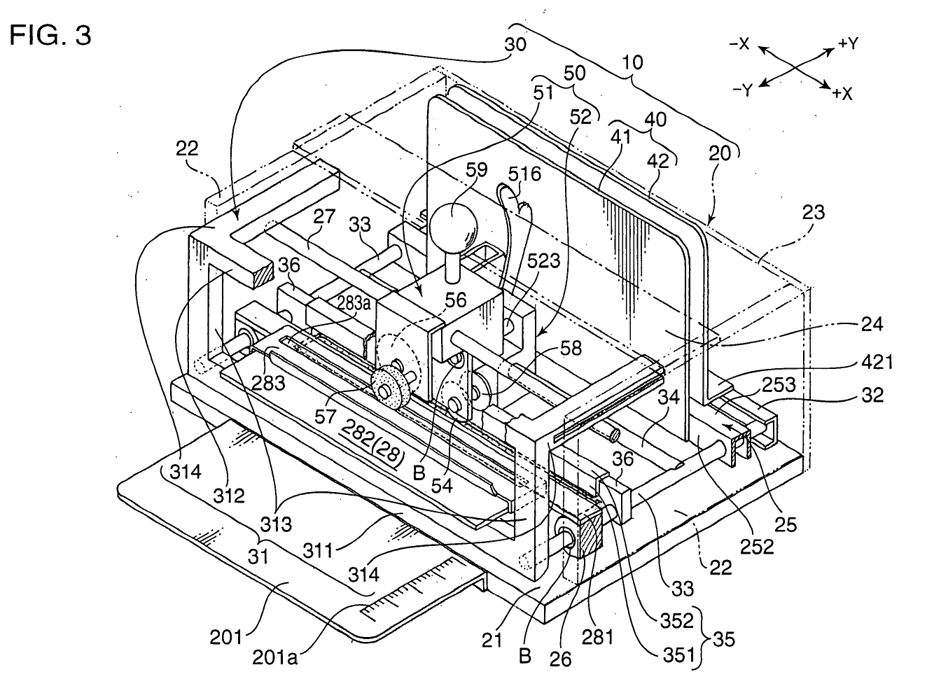

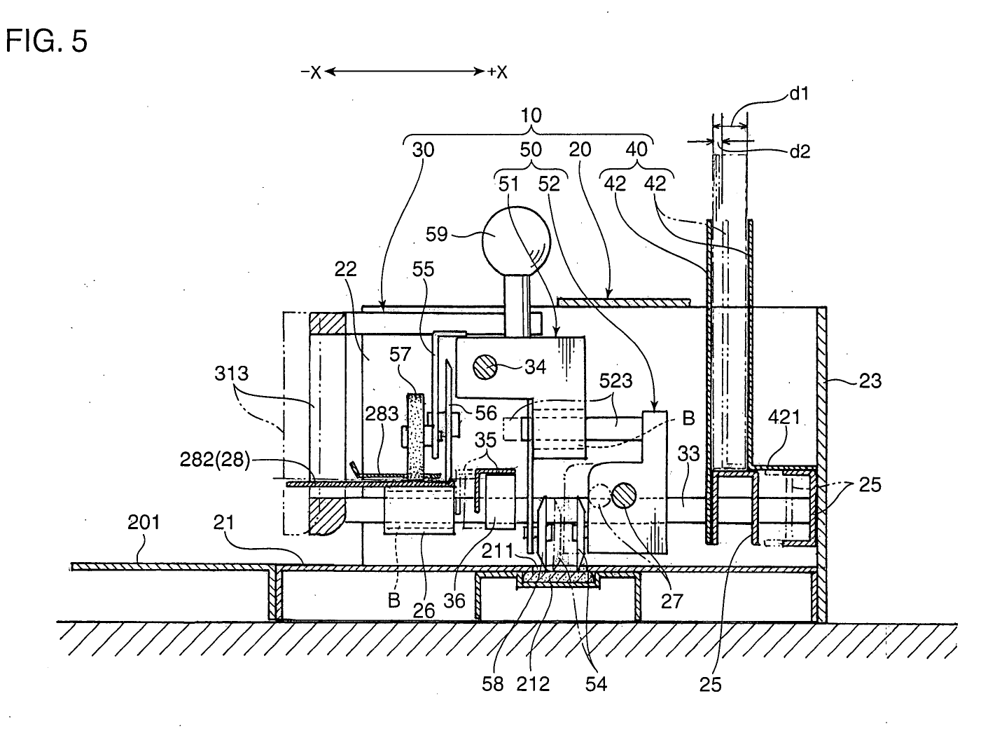

FIG. 2 is an exploded perspective view showing the bookbinding device 10 according to the present embodiment, and FIG. 3 and FIG. 4 are assembly perspective views thereof. FIG. 3 shows the internal structure by illustrating the left and right side plates and the rear plate with a chain double dash. FIG. 4 shows the left and right side plates and the rear plate with a solid line, additionally shows that the first and second processing blocks 51, 52 configuring the bookbinding processing execution unit (bookbinding processing unit) 50 are in a state of positioned at the home position. Moreover, FIG. 5 is a V-V cross section of FIG. 4. By way of reference, although FIG. 2 shows a state where the second processing block 52 has been assembled, the respective constituent members of the second processing block 52 are sequentially assembled in the first processing block 51 as a member on the fixed side during the actual assembly operation, thereby completing the second processing block 52. Incidentally, in FIG. 2 to FIG. 4, the X direction is the horizontal direction and the Y direction is the anteroposterior direction, and in particular −X is leftward, +X is rightward, −Y is forward, and +Y is backward.

As shown in FIG. 2 to FIG. 5, the bookbinding device 10 includes an immobile first frame 20 (first frame member) that is fixed at a prescribed position on a table or the like, a second frame 30 (second frame member) that is mounted on the first frame 20 and movable in relation to the first frame 20, a sheet bundle thickness measuring unit 40 respectively supported by the first and second frames 20, 30 and for measuring the thickness dimension of the sheet bundle 93, and a bookbinding processing unit 50 for obtaining the hot-melt adhesive 92 by cutting the mother adhesive 920.

The first frame 20 includes a bottom plate 21 (first stage) that is long and rectangular in the horizontal direction in a planar view, a pair of left and right side plates 22 that are arranged in an erect manner from the left and right edge portions of the bottom plate 21, a rear plate 23 suspended between the trailing edge portions of the pair of side plates 22, and an elongated top plate 24 suspended between the approximate center portions in the anteroposterior direction of the upper edge portions of the pair of side plates 22, and is formed in a rectangular shape in an external view. With the bottom plate 21, as shown in FIG. 5, each of the four edge portions of the rectangular plate body is bent toward the lower side. Consequently, the inside of the bottom plate 21 is hollow.

The first frame 20 is provided with a reverse U-shaped sheet bundle support beam 25 suspended between the lower rear parts of the pair of side plates 22. Moreover, the lower front position of the respective side plates 22 is provided with a bearing support 26 for supporting the slide ball bearing B at a position of the same height facing the sheet bundle support beam 25 anteriorly.

The left and right lateral parts of the sheet bundle support beam 25 are respectively drilled with a through-hole 251 to which an erection rod 33 described later is penetrated in a slidable contact state. Moreover, a first guide rod 27 as a guide rod on the first frame 20 side extending in the horizontal direction for guiding the movement of the first processing block 51 in the bookbinding processing unit 50 is suspended at the upper side position of the bearing support 26 between the respective side plates 22. In addition, an adhesive support plate 28 (hot-melt sheet cutting part) for supporting the sheet-shaped mother adhesive 920 as a raw material of the hot-melt adhesive 92 is suspended between the pair of bearing supports 26.

The adhesive support plate 28 is configured from an erection unit 281 in which the left and right end portions thereof are respectively supported by the respective bearing supports 26, and having a width dimension that is equal to the anteroposterior width dimension of the bearing support 26, and a mounting unit 282 provided protrusively from the leading edge portion of the erection unit 281 toward the anterior and in which the horizontal dimension is shorter than that of the erection unit 281. The mother adhesive 920 is mounted on the mounting unit 282, and the mother adhesive 920 is loaded into the first frame 20 upon performing the cutting processing.

An elongated square window 211 extending in the horizontal direction at a prescribed anteroposterior width dimension is cut out and formed in the bottom plate 21 of the first frame 20 at position that is slightly rear of the position to which the bearing support 26 is provided. A bottom rubber 212 for performing the creasing processing to the cover sheet 91 is laid down on the lower side of the bottom plate 21 and a position corresponding to the elongated square window 211.

In addition, the sheet tray 201 for mounting the cover sheet 91 to be processed is provided protrusively from the leading edge portion of the bottom plate 21. A calibration 201a is drawn at the appropriate location of the sheet tray 201 (right edge portion in the example illustrated in FIG. 2). The calibration 201a is used for showing how far the cover sheet 91 should be loaded into the first frame 20 according to the size of the sheet bundle 93. Specifically, for example, if the cover sheet 91 is for an A4 size sheet bundle 93, the calibration 201a is used so that the user will be able to know at which position of the calibration 201a the edge portion of the cover sheet 91 should be set, and, if the cover sheet 91 is for a B5 size sheet bundle 93, the calibration 201a is used so that the user will be able to know at which position of the calibration 201a the edge portion of the cover sheet 91 should be set.

The second frame 30 causes the sheet bundle thickness measuring unit 40 to function by moving it in the anteroposterior direction against the first frame 20 in a state of being mounted on such first frame 20. Moreover, second frame 30 causes the bookbinding processing unit 50 to function by moving the bookbinding processing unit 50 (FIG. 4) positioned at the home position toward the right side.

The second frame 30 includes an anterior frame material 31, a rear beam frame 32 placed opposite to the anterior frame material 31, a pair of left and right erection rods 33 that are suspended between the anterior frame material 31 and the rear beam frame 32, a second guide rod 34 as a guide rod on the second frame 30 side that is suspended between the pair of erection rods 33, and a patch plate 35 (hot-melt sheet cutting part/stop plate) that is suspended between the pair erection rods 33 at an anterior position of the second guide rod 34, and to which the posterior edge portion of the mother adhesive 920 is pressed against thereto in order to position the mother adhesive 920.

The anterior frame material 31 is of a horizontally long rectangular shape in a front view seen from the −Y direction, and includes a lower lateral frame 311 in a prismatic shape extending in the horizontal direction, an upper lateral frame 312 in a prismatic shape extending in the horizontal direction opposite the lower lateral frame 311 at the upper part thereof, a pair of left and right vertical frames 313 that are suspended between the left and right end portions of the upper and lower lateral frames 312, 311, and a pair of left and right protruding frames 314 that are provided protrusively from the left and right end portions of the upper lateral frame 312 toward the rear thereof, respectively.

The upper lateral frame 312 forms, as shown in FIG. 4, the front upper edge portion of the bookbinding device 10, and is of a structure that can be easily gripped by a user facing the bookbinding device 10 from the anterior. Accordingly, the upper lateral frame 312 functions as an operation bar for the user to move the second frame 30 forward and backward, and the user is able to grip the upper lateral frame 312 and move the second frame 30 forward and backward.

The protruding frame 314 is used for stabilizing the forward and backward movement of the second frame 30. Either the side plate 22 or the protruding frame 314 of the first frame 20 is provided with a guide groove that extends in the anteroposterior direction on the opposite side. Meanwhile, the other side is provided with a guide protrusion extending in the anteroposterior direction to which the guide groove is to be fitted at the opposite side of the other side. The second frame 30 is able to move forward and backward in a stable state as a result of the guide groove and the guide protrusion mutually being engaged in a slidable contact state.

The pair of erection rods 33 is provided protrusively from the left and right end portions of the lower lateral frame 311 toward the rear thereof. The erection rods 33 are inserted through the through-hole 251 of the slide ball bearing B and the sheet bundle support beam 25 provided to the bearing support 26 of the first frame 20 prior to the assembly of the second frame 30. Consequently, the second frame 30 is able to move, in an assembled state, forward and backward while slidably contacting the respective inner peripheral faces of the slide ball bearing B and the through-hole 251.

The second guide rod 34 extends in a direction that is parallel to the first guide rod 27, and is to be penetrated by the second processing block 52 (described later) of the bookbinding processing unit 50. Consequently, the second processing block 52 is able to move in the horizontal direction while being guided by the second guide rod 34.

The patch plate 35 is formed from a so-called angle material that is formed in a right-angled needle shape in a cross sectional view. The patch plate 35 is suspended between a pair of brackets 36 in the horizontal direction that are externally engaged and fixed at a position that is slightly anterior to the second guide rod 34 in the pair of erection rods 33, and its direction is set so that the outer surface of one becomes a vertical plane 351 facing the anterior, and the outer surface of the other becomes a horizontal plane 352. The vertical plane 351 moves closer to or away from the right end of the adhesive support plate 28.

Incidentally, the mounting of the bracket 36 on the erection rod 33 is performed after the erection rod 33 is inserted into the slide ball bearing B of the bearing support 26 or into the through-hole 251 of the sheet bundle support beam 25. The bracket 36 is fixed on the erection rod 33 by way of welding or a screw after its positioning on the erection rod 33 is determined.

With this kind of patch plate 35, the approximate center portion of the vertical plane 351 in the vertical direction is positioned to face the top surface of the adhesive support plate 28 of the first frame 20. In a state where the second frame 30 is maximally loaded into the first frame 20, a gap having the same dimension as the dimension between the fixed plate 41 (fixed piece/first thickness measuring piece) and the movable plate 42 (movable piece/second thickness measuring piece) is formed between the vertical plane 351 of the patch plate 35 and the trailing edge portion of the erection unit 281 of the adhesive support plate 28. The second frame 30 is able to move between a position where the rear beam frame 32 of the second frame 30 comes in contact with the rear plate 23, and a position where the vertical plane 351 of the patch plate 35 comes in contact with the adhesive support plate 28.

The sheet bundle thickness measuring unit 40 includes a fixed plate 41 and a movable plate 42 with which one face and the other face of the sheet bundle to be bound come in contact. The fixed plate 41 is arranged in an erect manner at a position between the pair of erection rods 33 in a state where the lower edge is fixed to the front face 252 of the sheet bundle support beam 25 of the first frame 20. The horizontal dimension of the fixed plate 41 is set to be slightly shorter than that of the sheet bundle support beam 25.

The movable plate 42 is placed opposite to the fixed plate 41, and is arranged in an erect manner in a state where the lower part is fixed to the rear beam frame 32 of the second frame 30. The movable plate 42 includes a bend piece 421 formed by the lower part thereof being bent orthogonal toward the rear, and the bend piece 421 is fixed to the top surface 321 of the rear beam frame 32 of the second frame 30. The anteroposterior width dimension of the bend piece 421 is set for that the leading edge portion thereof will be mounted on the top surface of the sheet bundle support beam 25 of the first frame 20 in a state where the rear beam frame 32 is moved to the rear until it stops at the rear plate 23 of the first frame 20.

The top surface of the sheet bundle support beam 25 is formed with a sheet bundle support face 253 for supporting the sheet bundle 93 that is sandwiched between the fixed plate 41 and the removable plate 42.

The movable plate 42 is movable in a direction (first direction) facing the fixed plate 41. The internal dimension between the fixed plate 41 and the movable plate 42 can be freely changed, as shown in FIG. 5, from a maximum length d1 in a state where the rear beam frame 32 has stopped at the rear plate 23 to the minimum length d2 in a state where the vertical plane 351 of the patch plate 35 has stopped at the trailing edge portion of the adhesive support plate 28. By way of reference, in the present embodiment, the maximum length d1 is set to 13 mm and the minimum length d2 is set to 3 mm. This shows that the bookbinding device 10 according to the present embodiment is able to perform the bookbinding processing of the sheet bundle 93 in a thickness dimension of 3 mm to 13 mm.

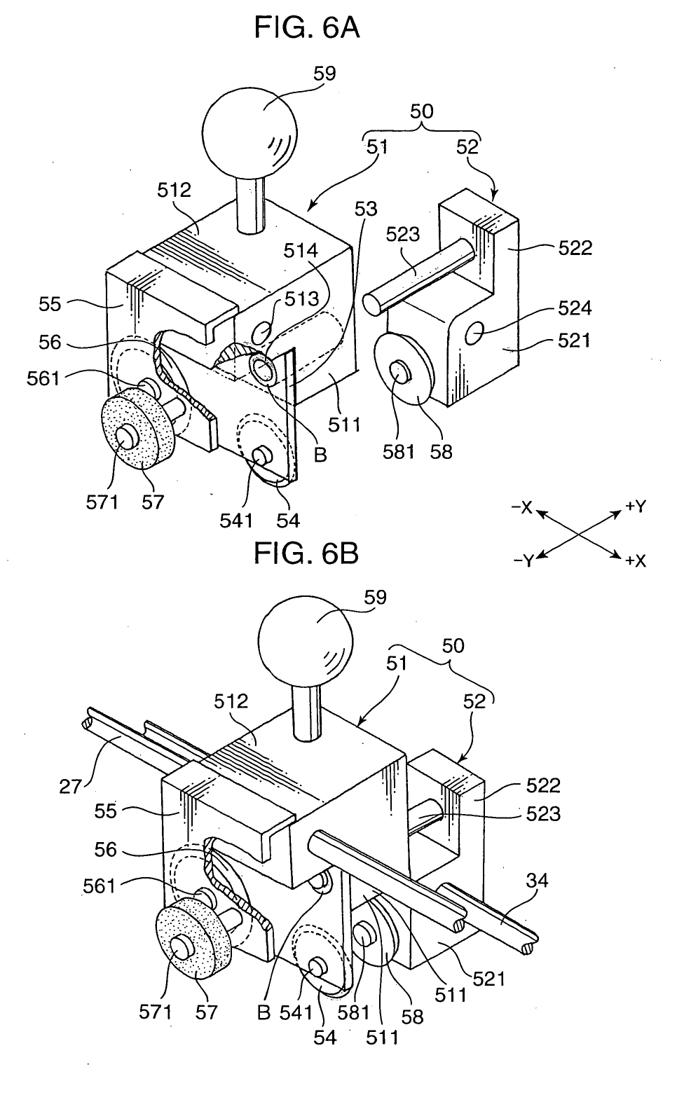

The bookbinding processing unit 50 (crease blade processing part and hot-melt sheet cutting part) is now explained with reference to FIG. 6A and FIG. 6B as well as other drawings as needed. FIG. 6A and FIG. 6B are perspective views showing the bookbinding processing unit 50, wherein FIG. 6A is a partial cutaway exploded perspective view thereof, and FIG. 6B is a partial cutaway assembly perspective view thereof. Incidentally, the direction of X and Y in FIG. 6A and FIG. 6B is the same as the case shown in FIG. 2 (−X: leftward, +X: rightward, −Y: forward, +Y: backward).

The bookbinding processing unit 50 includes a first processing block 51 that is movable in the horizontal direction (second direction) by being guided by the first guide rod 27 of the first frame 20 in a state of its movement being restricted in the anteroposterior direction, and a second processing block 52 that is movable toward the horizontal direction (second direction) by being guided by the second guide rod 34 of the second frame 30, and also movable in the anteroposterior direction (first direction) by accompanying the forward and backward movement of the second frame 30.

The first processing block 51 includes a block body 511 of an approximate square shape in a side view when seen from the X direction, and an overhang 512 that is oblong in a side view that is extended to the top surface of the block body 511 and in which the front end protrudes slightly anterior than the block body 511. A first through-hole 513 penetrating in the horizontal direction is drilled at a forward position of the overhang 512. The first through-hole 513 is externally engaged in a slidable contact state with the first guide rod 27 of the first frame 20. Consequently, the first processing block 51 is able to move in the horizontal direction by being guided by the first guide rod 27 in a state where its movement is restricted to the anteroposterior direction.

The block body 511 is drilled with a bearing mount hole 514 extending in the anteroposterior direction for internally inserting the slide ball bearing B. The top surface of the overhang 512 is protrusively provided with an operation knob toward the upper side for operating the movement of the bookbinding processing unit 50. The user is able to move the bookbinding processing unit 50 and the movable plate 42 by gripping and operating the operation knob 59, and thereby measure the thickness of the sheet bundle 93, perform the processing of creating a crease in the cover sheet 91, and perform the cutting processing to the mother adhesive 920 so as to obtain the hot-melt adhesive 92 of a prescribed width.

The block body 511 is provided with a crease blade mounting plate 53 that is fixed to the front face and hung a prescribed length, and the overhang 512 is provided with a cutter mount plate 55 that is fixed to the front end top surface thereof and hung. The rear face side of the crease blade mounting plate 53 is provided with a first circular creasing blade 54 (fixed crease blade/first crease blade) for creating one of the creases in the cover sheet 91. The rear face side of the cutter mount plate 55 is provided with a circle cutter 56 (cutting blade) for performing the cutting processing of the mother adhesive 920.

The first circular creasing blade 54 is a rotating blade that is axially supported rotatably about the first support shaft 541 extending in the anteroposterior direction that was mounted by penetrating an appropriate position of the crease blade mounting plate 53. Moreover, the circle cutter 56 is axially supported rotatably about the cutter axis 561 that was mounted by penetrating the cutter mount plate 55.

The front face side of the cutter mount plate 55 is provide with a rubber roller 57 (roller member) that is axially supported rotatably about a roller axis 571 that is provided protrusively from the cutter mount plate 55 toward the anterior thereof. The rubber roller 57 presses the mother adhesive 920 (FIG. 4) mounted on the adhesive support plate 28 (second stage) of the first frame 20. Consequently, the cutting processing of the mother adhesive 920 can be performed stably.

Meanwhile, the mounting unit 282 of the adhesive support plate 28 is provided with an adhesive retainer plate 283 in a state where it is separated from the top surface thereto for the thickness dimension of the mother adhesive 920. The adhesive retainer plate 283 is provided with a guide opening 283a extending in the horizontal direction for penetrating the rubber roller 57. The rubber roller 57 rotates while pressing the mother adhesive 920 mounted on the mounting unit 282 of the adhesive support plate 28 via the guide opening 283a as a result of the bookbinding processing unit 50 moving in the horizontal direction. Consequently, the mounted status of the mother adhesive 920 can be stabilized.

The second processing block 52 includes a block body 521 of an approximate square shape in a side view seen from the X direction, an extended body 522 of a rectangular shape extended from the rear top surface of the block body 521 toward the upper side thereof, a linking cylindrical body 523 (linking mechanism) that is provided protrusively from the front face of the extended body 522 toward the anterior thereof, and a second circular creasing blade 58 (moving crease blade/second crease blade) that is provided protrusively from the front face of the block body 521 toward the anterior thereof and axially supported rotatably about the second support shaft 581.

The linking cylindrical body 523 is inserted through the slide ball bearing B of the first processing block 51. The slide ball bearing B is fit by insertion into the bearing mount hole 514 that was drilled in the block body 511 so as to extend in the anteroposterior direction. As a result of the linking cylindrical body 523 being inserted through the slide ball bearing B, the second processing block 52 will be synchronized with the first processing block 51 so as to secure the smooth forward and backward movement and enable movement in the horizontal direction by accompanying the leftward and rightward movement of the first processing block 51.

The front upper portion of the block body 521 is provide with a second through-hole 524 that is externally engaged in a slidable contact state with the second guide rod 34 of the second frame 30 by being penetrated therethrough in the horizontal direction. As a result of the second guide rod 34 being penetrated through the second through-hole 524, the second processing block 52 is able to move leftward and rightward by being guided by the second guide rod 34.

The posterior surface leftward position of the first processing block 51 is provided with a bracket 515 as shown in FIG. 2 to FIG. 4. The bracket 515 is mounted with a stopper 516 rotatably about an axis (not shown)extending in the horizontal direction. The stopper 516 is used for restricting the movement of the second frame 30 in the anteroposterior direction after the sheet bundle thickness measuring unit 40 measures the thickness dimension of the sheet bundle 93. The stopper 516 is able to change the posture between a release posture of the erected state shown with the solid line of FIG. 4, and a locked posture of being inclined toward the rear shown with the chain double dash of FIG. 4.

The stopper 516 in a state of being set in the locked posture is configured such that an appropriate position of its lower part locks with the first frame 20 of the linking cylindrical body 523 of the second processing block 52, and, consequently, to prevent movement in the anteroposterior direction of the second processing block 52. Accordingly, in a state where the stopper 516 is set in the locked posture, even if the first processing block 51 and the second processing block 52 are moved in the horizontal direction, the second processing block 52 will not move in the anteroposterior direction during the foregoing movement. Consequently, it is possible to prevent drawbacks such as not being able to create two creases 911 in the sheet bundle 93 in parallel, or not being able to obtain the hot-melt adhesive 92 with an appropriate width dimension.

In this embodiment, the measuring operation of the sheet bundle thickness to be performed by the sheet bundle thickness measuring unit 40 is synchronized with the operation of determining the distance between the pair of creases 911 to be formed in the cover sheet 91 and the width dimension of the hot-melt adhesive 92. The synchronization mechanism includes a second frame 30 that moves forward and backward in relation to the first frame 20 in accordance with the thickness of the sheet bundle 93, a second circular creasing blade 58 facing the first circular creasing blade 54 provided to the first frame 20 so as to accompany and move together with the second frame 30, and a patch plate 35 that moves in accordance with the second frame 30 for positioning the mounted state of the mother adhesive 920 on the adhesive support plate 28.

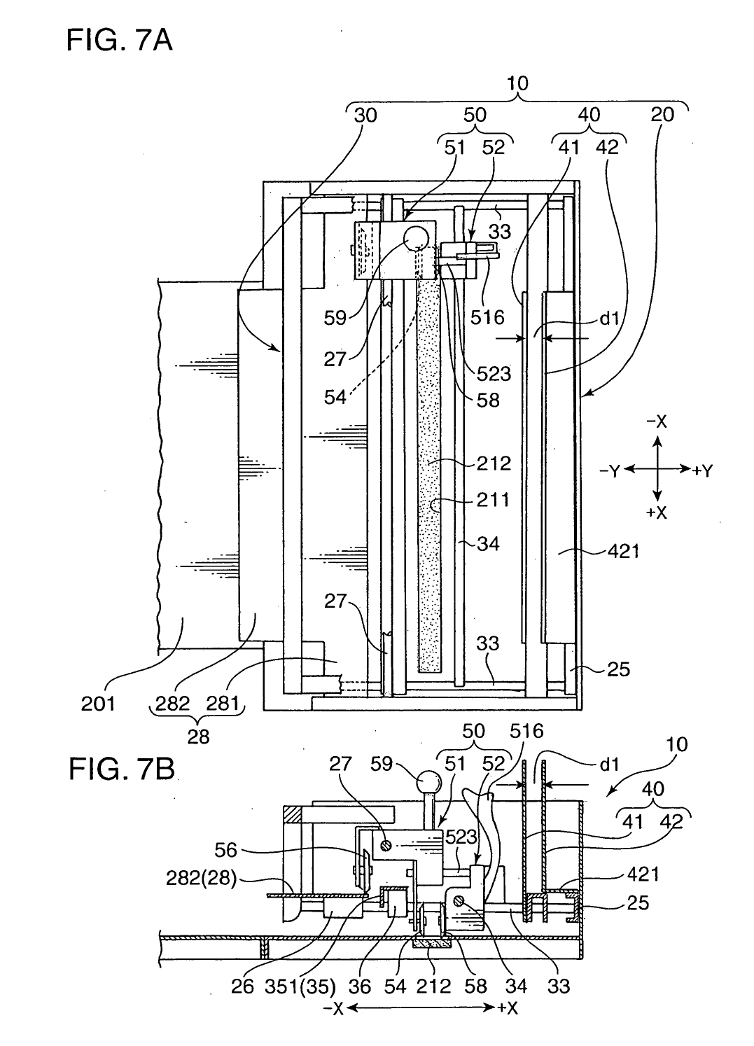

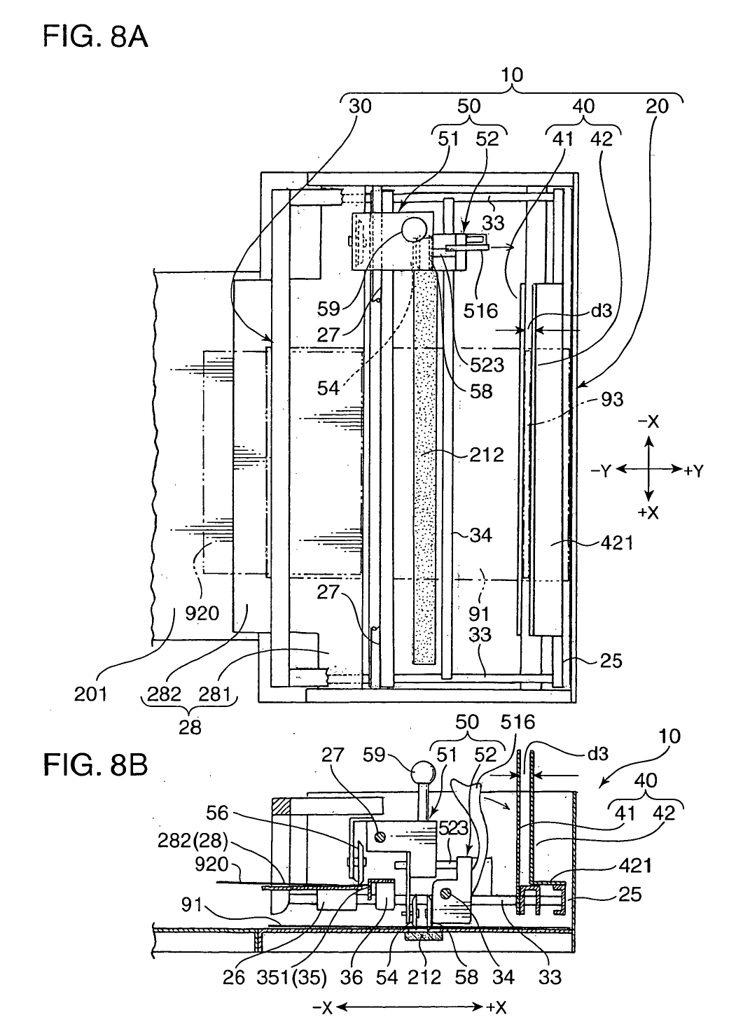

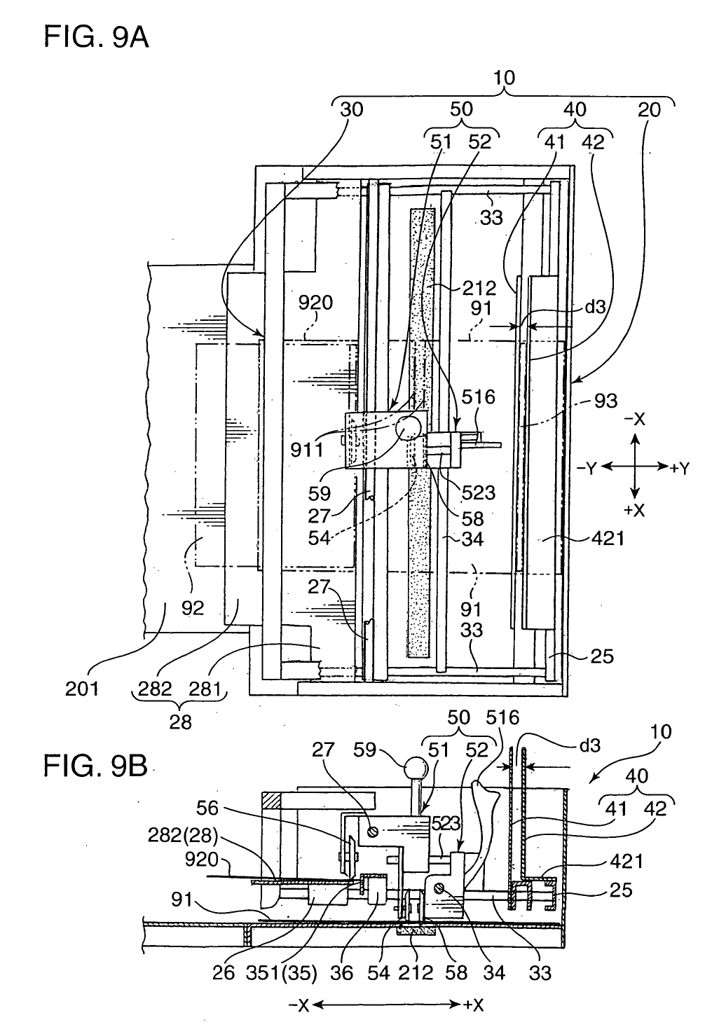

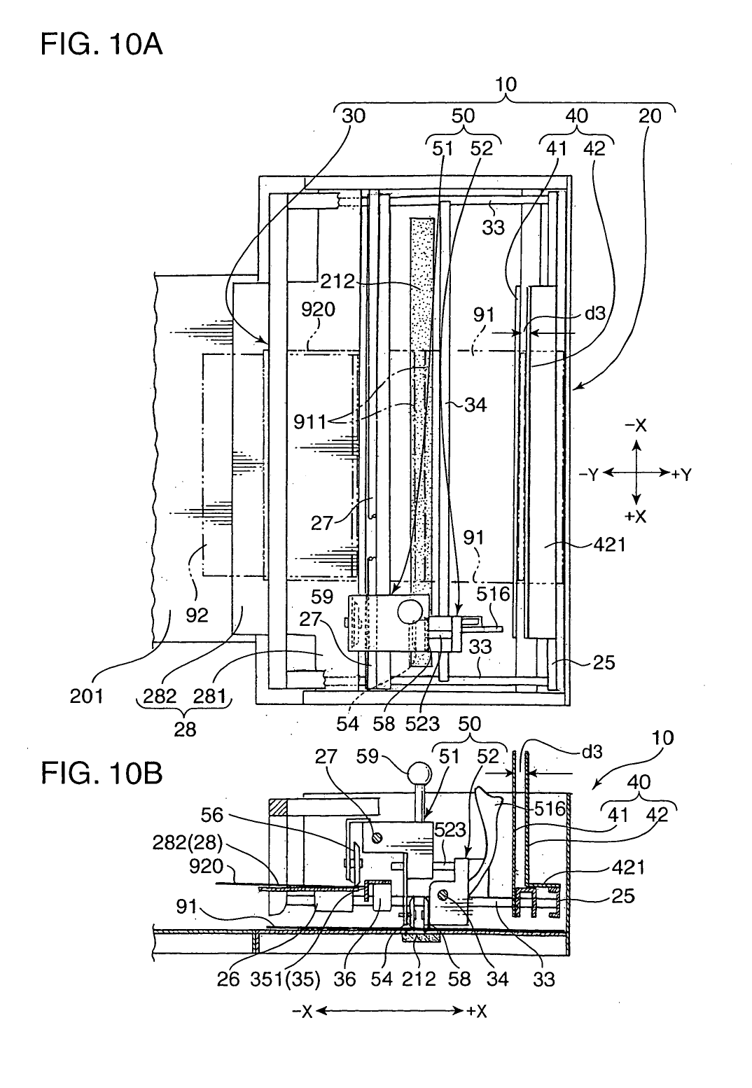

The operation of the bookbinding device 10 comprising the synchronization mechanism according to the present embodiment is now explained with reference to FIG. 7A to FIG. 10B. FIG. 7A to FIG. 10B are explanatory diagrams explaining the operation of the bookbinding device 10, where FIG. 7A, FIG. 8A, FIG. 9A and FIG. 10A are explanatory diagrams showing the planar view, and FIG. 7B, FIG. 8B, FIG. 9B and FIG. 10B are explanatory diagrams showing the lateral cross sectional view. FIG. 7A and FIG. 7B show the initial state of the bookbinding device 10 prior to performing the bookbinding processing, FIG. 8A and FIG. 8B show a state where the thickness of the sheet bundle 93 to be bound has been measured with the sheet bundle thickness measuring unit 40, FIG. 9A and FIG. 9B show a state where the bookbinding processing unit 50 is being moved from the home position toward the right side, and FIG. 10A and FIG. 10B show a state where the bookbinding processing unit 50 has been moved to the rightmost end, respectively. Incidentally, the direction of X and Y in FIG. 7A to FIG. 10B is the same as the case of FIG. 2 (−X: leftward, +X: rightward, −Y: forward, +Y: backward).

Foremost, as shown in FIG. 7A and FIG. 7B, in the initial state of the bookbinding device 10 according to this embodiment prior to performing the bookbinding processing, the bookbinding processing unit 50 is positioned at the leftmost home position of the first frame 20, and the second frame 30 is positioned at the rearmost position. Consequently, the internal dimension between the fixed plate 41 and the movable plate 42 is set to the maximum length d1. Moreover, the stopper 516 is set to the release posture and, consequently, the second frame 30 is able to move toward the anteroposterior direction.

Subsequently, the sheet bundle 93 is inserted in the gap between the fixed plate 41 and the movable plate 42 in order to measure the thickness of the sheet bundle 93 to be bound, and the upper lateral frame 312 of the second frame 30 is pulled toward the anterior in this status. Consequently, as shown in FIG. 8A and FIG. 8B, the movable plate 42 moves toward the anterior via the pair of erection rods 33, and the sheet bundle 93 will be held between the fixed plate 41 and the movable plate 42.

In the foregoing state, if the user grips the operation knob 59 and operates it rightward, the second processing block 52 will accompany and move together with the first processing block 51 along the erection rod 33. In connection with this, the second circular creasing blade 58 provided to the second processing block 52 will also move toward the first circular creasing blade 54 of the first processing block 51 on the bottom rubber 212. Consequently, the distance between the first and second circular creasing blades 54, 58 will be the same as the distance between the fixed plate 41 and the movable plate 42 (that is, the thickness dimension d3 of the sheet bundle 93).

Moreover, the patch plate 35 of the second frame 30 will also accompany the movement of the erection rod 33 and move toward the anterior. Consequently, the distance between the vertical plane 351 of the patch plate 35 and the blade edge of the circle cutter 56 of the first frame 20 will also be the same as the thickness dimension d3 of the sheet bundle 93.

In this state, the cover sheet 91 is mounted on the sheet tray 201 of the first frame 20, and inserted into the first frame 20 for a prescribed distance by sliding the top surface of the bottom plate 21. Moreover, the hot-melt adhesive 92 is mounted on the mounting unit 282 of the adhesive support plate 28 and inserted into the first frame 20. Subsequently, the stopper 516 that was previously set in the release posture is changed to the locked posture by being inclined toward the rear as shown with the arrows in FIG. 8A. Consequently, the second frame 30 will be locked against the first frame 20, and the relative positional relationship between the first and second frames 20, 30 will be locked.

Subsequently, the operation knob 59 is gripped and operated rightward and, consequently, the first and second processing blocks 51, 52 are moved toward the right side as shown in FIG. 9A. Pursuant to this movement, a mutually parallel pair of creases 911 will be formed at the center of the cover sheet 91 in the anteroposterior direction with the first and second circular creasing blades 54, 58. Simultaneously, the posterior portion of the mother adhesive 920 is cut rightward with the circle cutter 56.

Then, as shown in FIG. 10A, when the first and second processing blocks 51, 52 reach the right end portion of the bookbinding device 10, the creation of the creases 911 in the cover sheet 91 is completed, and a strip-shaped hot-melt adhesive 92 is formed from the mother adhesive 920 based on the cutting processing.

Finally, the cover sheet 91 that was subject to the crease processing and the hot-melt adhesive 92 are removed from the bookbinding device 10. Then, as previously explained with reference to FIG. 1, the cover sheet 91 is folded along the two creases 911 so that one side and the other side face each other, and the hot-melt adhesive 92 is mounted on the inner face side of the obtained back cover 912. Subsequently, as a result of the end of the sheet bundle 93 being heated with a prescribed heater in a state of being overlapped with the hot-melt adhesive 92, the hot-melt adhesive 92 will melt, and function as an adhesive. The bookbinding processing is thereby complete.

As explained in detail above, the bookbinding device 10 according to the present embodiment includes a sheet bundle thickness measuring unit 40 including the movable plate 42 that moves according to the thickness of the sheet bundle 93 to be bound, a bookbinding processing unit 50 for performing bookbinding processing in a state of being positioned at a prescribed processing position, and a synchronization mechanism for changing the processing position of the bookbinding processing unit 50 in synchronization with the movement of the movable plate 42. Consequently, without having to adopt a complex mechanism as with the conventional technology, the bookbinding processing can be executed in a simple and convenient manner merely by measuring the thickness of the sheet bundle 93 and thereafter executing prescribed operations for performing the bookbinding processing.

In addition, since the bookbinding device 10 performs prescribed processing for the bookbinding processing only with synchronized operations, it can be manufactured inexpensively in comparison to the conventional expensive bookbinding device that was fully automated, and this will contribute to the cost reduction of the device cost.

The bookbinding device 10 additionally includes an immobile first frame 20, and the synchronization mechanism includes the second frame 30 that is movable in relation to the first frame 20, and the sheet bundle thickness measuring unit 40 includes the fixed plate 41 mounted on the first frame 20. Moreover, the movable plate 42 is mounted on the second frame 30 facing the fixed plate 41 so as to be capable of holding the sheet bundle 93. In addition, the processing component for determining the processing position of the bookbinding processing unit 50 is mounted on the second frame 30.

According to the foregoing configuration, the bookbinding device 10 having necessary and sufficient functions required for bookbinding processing with a simple structure can be achieved by adopting a configuration of providing a movable second frame with various functions to the immobile first frame with various functions.

Moreover, the bookbinding processing unit 50 is provided with a crease blade member for creating creases 911 that partition the back cover 912 from the cover sheet 91 covering the sheet bundle 93. As the crease blade member, provided are first and second circular creasing blades 54, 58 that respectively rotate about the first and second support shafts 541, 581. Accordingly, as a result of moving the bookbinding processing unit 50, appropriate creases 911 can be created without damaging the cover sheet 91 since the first and second support shafts 541, 581 rotate and create the creases 911 in the cover sheet 91.

Moreover, the bookbinding processing unit 50 includes the adhesive support plate 28 and the patch plate 35 as the cutting part of the hot-melt adhesive 92 which is disposed on the inside of the back cover face and bonds the one side of the sheet bundle 93 and the back cover face. The position of the cutting part is set so that the hot-melt adhesive 92 corresponds to the thickness of the sheet bundle 93 in synchronization with the measurement of the thickness of the sheet bundle 93 by the sheet bundle thickness measuring unit 40. Consequently, since it is not necessary to measure the dimension with a tape measure every time, the formation of the hot-melt adhesive 92 in correspondence with the thickness of the sheet bundle 93 is facilitated.

In addition, the circle cutter 56 is movably mounted on the first frame 20 and cuts the hot-melt adhesive 92 from a front end edge of the hot-melt adhesive 92 at a width position corresponding to the thickness of the sheet bundle 93 in a state where the front end edge is in contact with the patch plate 35. Consequently, the hot-melt adhesive 92 can be easily cut from the mother adhesive 920 with the circle cutter 56 provided to the cutting part at a width position corresponding to the thickness of the sheet bundle 93.

The present invention is not limited to the foregoing embodiment, and also covers the following subject matter.

(1) In the foregoing embodiment, although the first circular creasing blade 54 and the second circular creasing blade 58 are disposed so as to face each other, they may also be provided so as to be mutually displaced in the horizontal direction. Consequently, the first and second circular creasing blades 54, 58 can be moved to mutually closer position.
(2) In the foregoing embodiment, the distance between the first and second circular creasing blades 54, 58 may also be made to be slightly greater than the thickness dimension d3 of the sheet bundle 93, and the distance between the vertical plane 351 and the blade edge of the circle cutter 56 may also be made to be slightly smaller than the thickness dimension d3 of the sheet bundle 93.
(3) In the foregoing embodiment, the fixed plate 41 and the movable plate 42 are adopted as the fixed piece and the movable piece to be provided to the sheet bundle thickness measuring unit 40. However, the fixed piece and the movable piece are not limited to being plates, and may be of a rod shape where a plurality of pieces are arranged in an erect manner, or of a net shape.
(4) In the foregoing embodiment, the first and second circular creasing blades 54, 58 that rotate about a prescribed axis are adopted as the crease members. In substitute, for example, a slidable contact pressure member such as a paper knife may also be adopted.
(5) In the foregoing embodiment, the sheet tray 201 for mounting the cover sheet 91 may be provided with a cursor that comes in contact with the anterior edge portion of the cover sheet 91 as well as a dial for moving the cursor forward and backward, and the cover sheet 91 may be positioned on the sheet tray 201 based on the movement of the cursor based on the foregoing dial operation. In the foregoing case, preferably, the respective calibrations according to the size of the sheet bundle 93 to be bound; that is, according to the size of the cover sheet 91 are respectively provided to the dial. Consequently, the cover sheet 91 can be easily positioned on the sheet tray 201 merely by selecting the calibration of the size of the cover sheet 91 and operating the dial according to the selected calibration.

Incidentally, the specific embodiments described above mainly include the invention having the following configurations.

The bookbinding device according to one aspect of the present invention includes a thickness measuring unit including a movable piece that moves according to the thickness of a sheet bundle to be bound, a bookbinding processing unit for performing bookbinding processing in a state of being positioned at a prescribed processing position, and a synchronization mechanism for changing the processing position of the bookbinding processing unit in synchronization with the movement of the movable piece.

According to the foregoing configuration, the movable piece moves in accordance with the thickness of the sheet bundle, and the processing position of the prescribed processing of the bookbinding processing unit is changed in synch with the movement of the movable piece. Accordingly, the operator is able to performing appropriate bookbinding according to the thickness of the sheet bundle merely by measuring the sheet bundle thickness and subsequently executing the bookbinding processing.

In the foregoing configuration, the configuration may further comprise an immobile first frame member, wherein the synchronization mechanism includes a second frame member that is movable in relation to the first frame member, the thickness measuring unit includes a fixed piece mounted on the first frame member, and the movable piece is mounted on the second frame member facing the fixed piece so as to be capable of holding the sheet bundle, and a processing component for determining the processing position of the bookbinding processing unit is mounted on the second frame member. According to the foregoing configuration, necessary and sufficient functions can be provided with a simple structure by adopting a configuration of providing a movable second frame to the immobile first frame.

In the foregoing case, the bookbinding processing unit preferably includes a crease blade member for creating a crease that partitions a back cover face from a cover sheet covering the sheet bundle, and the crease blade member preferably includes a moving crease blade mounted on the second frame member as the processing component. According to the foregoing configuration, a crease will be formed in the cover sheet with the moving crease blade in correspondence with the thickness of the sheet bundle. Consequently, the cover sheet can be easily and finely folded along the crease.

Moreover, the crease blade member preferably further includes a fixed crease blade mounted on the first frame member. According to the foregoing configuration, in addition to the crease corresponding to the second frame member, a crease is also formed with the fixed crease blade of the first frame member. Consequently, the cover sheet can be folded easily and finely along these two creases. Accordingly, the sheet bundle can be attached to the cover in positioned state with a simple operation of placing the sheet bundle between two folding lines of the folded cover.

In the foregoing configuration, the bookbinding processing unit may include a cutting part of a hot-melt sheet that is disposed on the inside of the back cover face, and bonds one side of the sheet bundle and the back cover face, and the cutting part may includes, as the processing component, an abutting plate which is mounted on the second frame member and with which a front end edge of the hot-melt sheet comes in contact. According to the foregoing configuration, the cutting part is set to be positioned so that the hot-melt sheet will correspond to the thickness of the sheet bundle in synchronization with the measurement of the thickness of the sheet bundle by the thickness measuring unit. Consequently, since it is not necessary to measure the dimension with a tape measure every time, the formation of the hot-melt sheet in correspondence with the thickness of the sheet bundle is facilitated.

In the foregoing case, preferably, the cutting part further includes a cutting blade that is movably mounted on the first frame member, and cuts the hot-melt sheet from a front end edge of the hot-melt sheet at a width position corresponding to the thickness of the sheet bundle in a state where the front end edge of the hot-melt sheet is in contact with the abutting plate. According to the foregoing configuration, the hot-melt sheet is cut with a cutting blade provided to the cutting part at the width position corresponding to the thickness of the sheet bundle.

The bookbinding device according to another aspect of the present invention includes a first frame member, a second frame member that moves relatively to the first frame member, a first thickness measuring piece with which one face of a sheet bundle to be bound comes in contact and which is mounted on the first frame member, a second thickness measuring piece with which the other face of the sheet bundle comes in contact and which is mounted on the second frame member facing the first thickness measuring piece, a crease blade processing part for creating a crease that partitions a back cover face from a cover sheet covering the sheet bundle, and a cutting part of a hot-melt sheet that is disposed on the inside of the back cover face, and bonds one side of the sheet bundle and the back cover face, wherein the crease blade processing part includes a first crease blade mounted on the first frame member and a second crease blade mounted on the second frame member, and the cutting part includes a cutting blade which is mounted on the first frame member and cuts the hot-melt sheet, and an abutting plate which is mounted on the second frame member and with which a front end edge of the hot-melt sheet comes in contact.

According to the foregoing configuration, the second frame member moves relative to the first frame member according to the thickness of the sheet bundle. Pursuant to this movement, the position of the second crease blade in relation to the first crease blade and the position of the abutting plate in relation to the cutting blade are determined, and the crease blade processing of the cover sheet according to the thickness of the sheet bundle as well as the cutting of the hot-melt sheet are performed. Accordingly, the bookbinding setting according to the thickness of the sheet bundle is achieved merely by sandwiching the sheet bundle between the first and second thickness measuring pieces.

In the foregoing configuration, preferably, the bookbinding device further comprises a first guide rod that is provided to the first frame member and extends in a second direction that is orthogonal to a first direction in which the first and second thickness measuring pieces face each other, a second guide rod that is provided to the second frame member and extends in a direction that is parallel to the first guide rod, a first processing block that moves in the second direction by being guided by the first guide rod, and a second processing block that moves in the second direction by being guided by the second guide rod, wherein the first crease blade and the cutting blade are mounted on the first processing block, and the second crease blade is mounted on the second processing block. According to the foregoing configuration, the crease blade processing and the cutting of the hot-melt sheet are performed as a result of the first and second processing blocks moving along the first and second guide rods.

In the foregoing case, preferably, the bookbinding device further comprises a linking mechanism for linking the first processing block and the second processing block so as to move the second processing block in accordance with the movement of the first processing block in the second direction while allowing the movement of the second processing block in the first direction in relation to the first processing block. According to the foregoing configuration, the first processing block and the second processing block can be synchronized by being relatively movable during the positioning process. The user's operability can thereby be improved.

Moreover, the configuration may further comprise a first stage on which the cover sheet is mounted, wherein the first crease blade and the second crease blade are rotating blades, and are disposed facing the first stage, and during the movement of the first processing block and the second processing block in the second direction, the first crease blade and the second crease blade create, in the cover sheet on the first stage, a crease extending in the second direction while rotating. According to the foregoing configuration, a crease can be created by rotating and running the first crease blade and the second crease blade on the cover sheet mounted on the first stage.

In addition, the configuration may further comprise a second stage which is supported by the first frame member and on which the hot-melt sheet is mounted, wherein the abutting plate includes a vertical plane that moves closer to or away from the second stage. According to the foregoing configuration, the user will be able to reliably position the hot-melt sheet by moving the vertical plane of the abutting plate in a state of mounting the hot-melt sheet on the second stage.

In the foregoing case, preferably, a roller member that is mounted on the first processing block and presses the hot-melt sheet mounted on the second stage. According to the foregoing configuration, the cutting processing of the hot-melt sheet can be performed stably.

This application is based on Japanese patent application serial no. 2008-241481, filed in Japan Patent Office on Sep. 19, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A bookbinding device, comprising:
a thickness measuring unit including a movable piece that moves according to the thickness of a sheet bundle to be bound;
a bookbinding processing unit for performing bookbinding processing in a state of being positioned at a prescribed processing position; and
a synchronization mechanism for changing the processing position of the bookbinding processing unit in synchronization with the movement of the movable piece.

2. The bookbinding device according to claim 1, further comprising:
an immobile first frame member; wherein
the synchronization mechanism includes a second frame member that is movable in relation to the first frame member,
the thickness measuring unit includes a fixed piece mounted on the first frame member, and the movable piece is mounted on the second frame member facing the fixed piece so as to be capable of holding the sheet bundle, and
a processing component for determining the processing position of the bookbinding processing unit is mounted on the second frame member.

3. The bookbinding device according to claim 2, wherein
the bookbinding processing unit includes a crease blade member for creating a crease that partitions a back cover face from a cover sheet covering the sheet bundle, and
the crease blade member includes a moving crease blade mounted on the second frame member as the processing component.

4. The bookbinding device according to claim 3, wherein
the crease blade member further includes a fixed crease blade mounted on the first frame member.

5. The bookbinding device according to claim 2, wherein
the bookbinding processing unit includes a cutting part of a hot-melt sheet that is disposed on the inside of the back cover face, and bonds one side of the sheet bundle and the back cover face, and
the cutting part includes, as the processing component, an abutting plate which is mounted on the second frame member and with which a front end edge of the hot-melt sheet comes in contact.

6. The bookbinding device according to claim 5, wherein
the cutting part further includes a cutting blade that is movably mounted on the first frame member, and cuts the hot-melt sheet from a front end edge of the hot-melt sheet at a width position corresponding to the thickness of the sheet bundle in a state where the front end edge of the hot-melt sheet is in contact with the abutting plate.

7. A bookbinding device, comprising:
a first frame member;
a second frame member that moves relatively to the first frame member;
a first thickness measuring piece with which one face of a sheet bundle to be bound comes in contact and which is mounted on the first frame member;
a second thickness measuring piece with which the other face of the sheet bundle comes in contact and which is mounted on the second frame member facing the first thickness measuring piece;
a crease blade processing part for creating a crease that partitions a back cover face from a cover sheet covering the sheet bundle; and
a cutting part of a hot-melt sheet that is disposed on the inside of the back cover face, and bonds one side of the sheet bundle and the back cover face; wherein
the crease blade processing part includes a first crease blade mounted on the first frame member and a second crease blade mounted on the second frame member, and
the cutting part includes a cutting blade which is mounted on the first frame member and cuts the hot-melt sheet, and an abutting plate which is mounted on the second frame member and with which a front end edge of the hot-melt sheet comes in contact.

8. The bookbinding device according to claim 7, further comprising:
a first guide rod that is provided to the first frame member and extends in a second direction that is orthogonal to a first direction in which the first and second thickness measuring pieces face each other;
a second guide rod that is provided to the second frame member and extends in a direction that is parallel to the first guide rod;
a first processing block that moves in the second direction by being guided by the first guide rod; and
a second processing block that moves in the second direction by being guided by the second guide rod; wherein
the first crease blade and the cutting blade are mounted on the first processing block, and the second crease blade is mounted on the second processing block.

9. The bookbinding device according to claim 8, further comprising:
a linking mechanism for linking the first processing block and the second processing block so as to move the second processing block in accordance with the movement of the first processing block in the second direction while allowing the movement of the second processing block in the first direction in relation to the first processing block.

10. The bookbinding device according to claim 9, further comprising:
a first stage on which the cover sheet is mounted; wherein
the first crease blade and the second crease blade are rotating blades, and are disposed facing the first stage, and
during the movement of the first processing block and the second processing block in the second direction, the first crease blade and the second crease blade create, in the cover sheet on the first stage, a crease extending in the second direction while rotating.

11. The bookbinding device according to claim 9, further comprising:
a second stage which is supported by the first frame member and on which the hot-melt sheet is mounted; wherein
the abutting plate includes a vertical plane that moves closer to or away from the second stage.

12. The bookbinding device according to claim 11, further comprising:
a roller member that is mounted on the first processing block and presses the hot-melt sheet mounted on the second stage.
